(19) United States
(12) Patent Application Publication
(10) Pub. No.: US 2022/0092891 A1
(43) Pub. Date: Mar. 24, 2022

(54) PASSIVE SAFETY DESIGN SYSTEMS AND METHODS

(71) Applicant: MDGo Ltd., Tel-Aviv (IL)

(72) Inventors: Itay Bengad, Tel Aviv (IL); Gilad Avrashi, Haifa (IL)

(73) Assignee: MDGo Ltd., Tel-Aviv (IL)

(21) Appl. No.: 17/420,187

(22) PCT Filed: Jan. 3, 2020
(86) PCT No.: PCT/IB2020/050036

§ 371 Date: Jul. 1, 2021

Related U.S. Application Data
(60) Provisional application No. 62/788,626, filed on Jan. 4, 2019.

(51) Int. Cl. G07C 5/08; G07C 5/00

(52) U.S. Cl. CPC G07C 5/0808; G07C 5/008

(57) ABSTRACT

The present disclosure relates to a system and method for evaluating and reporting crash data suffered by one or more passengers and damage to a vehicle in the vehicular crash to a remote data processing system automatically and in real time. In various aspects, the system provides data to vehicle manufacturers, automobile insurance providers, and healthcare insurance providers to provide improved services to vehicle owners and passengers.

### CROSS-REFERENCE TO RELATED APPLICATIONS

This application claims the benefit of U.S. Provisional Application No. 62/788,626, filed Jan. 4, 2019, the contents of which are incorporated by reference herein in their entirety.

### FIELD OF THE PRESENT DISCLOSURE

The present disclosure is related to vehicle telematics systems, and in particular to systems and methods that may be used to improve vehicle safety and vehicle design. The disclosed systems and methods may also be used to improve insurance products and services for vehicle owners and passengers.

### BACKGROUND OF THE PRESENT DISCLOSURE

Vehicle crashes present a number of downstream effects on vehicle operators, which are inefficient, time consuming, and costly, which contribute to increased costs for vehicle insurance, medical insurance, hospital bills, and vehicle repair. Existing systems are based on low-resolution parameters, such as energy involved in a vehicle crash, in an effort to determine the effects on passengers and/or vehicles. These low-resolutions parameters and data sets contribute to a poor correlation to vehicle damage and personal injury, which causes inaccurate damage estimates and injury predictions, which lead to increased costs as insurance claims are resolved following more repairs and/or personal injury treatment.

### SUMMARY OF PRESENT DISCLOSURE

The present disclosure generally relates to systems and methods to solve the above-identified short comings of vehicle safety decision making (design, insurance policies, performance assessment) with no real-life data. In particular, the present disclosed systems and methods use real-time car-crash analysis in order to provide a variety of tools for automotive and insurance clients. When in use, real time car crash analysis data, including trauma analysis data obtained from existing vehicle sensors are used to generate immediate insights about the crash, its mechanism and the predicted injuries of all passengers involved. Furthermore, the real time car crash analysis data is used to inform vehicle safety.

In various embodiments, vehicle safety can be divided into three categories: preventive safety, crashworthiness, and post-crash safety. As used herein, preventive safety (or crash avoidance) includes systems such as automatic braking, obstacle avoidance, and driver alert systems, among others. Crashworthiness generally refers to vehicular systems and components to improve passenger safety during a crash including airbags, seatbelts and crumple zones, among others. Post-crash safety generally refers to passenger trauma analysis.

### BRIEF DESCRIPTION OF THE DRAWINGS

FIG. 1 is a diagrammatic view of a system for evaluating and reporting trauma to organs of passengers in a vehicular crash, according to at least one embodiment of the present disclosure.

FIG. 2A is an illustrative view of in-vehicle seatbelt sensors, according to at least one instance of the present disclosure.

FIG. 2B is an illustrative view of in-vehicle headrest sensors, according to at least one instance of the present disclosure.

FIG. 2C is an illustrative view of in-vehicle steering wheel sensors, according to at least one instance of the present disclosure.

FIG. 2D is a diagrammatic view of in-vehicle seat sensors, according to at least one instance of the present disclosure.

FIG. 2E is a diagrammatic view of a plurality of in-vehicle sensors, according to at least one instance of the present disclosure.

FIG. 3 is a block diagram of a sub-system for training of response functions for evaluating and reporting trauma in a vehicular crash, according to at least one instance of the present disclosure.

FIG. 4A is an illustrative view of a Graphic User Interface (GUI) of a medical examination report, according to at least one instance of the present disclosure.

FIG. 4B is an illustrative view of a Graphic User Interface (GUI) of a status information screen, according to at least one instance of the present disclosure.

FIG. 5 is a flow diagram of a method for evaluating and reporting trauma to organs of passengers in a vehicular crash, according to at least one instance of the present disclosure.

FIG. 6 is a flow diagram of a method for training of response functions for classification and virtual sensors in a kinetic engine of a system for evaluating and reporting trauma to organs of passengers in a vehicular crash, according to at least one instance of the present disclosure.

FIG. 7 is a flow diagram of a method for evaluating and reporting trauma to organs of passengers in a vehicular crash, according to at least one instance of the present disclosure.

FIG. 8 is a diagrammatic view of data analysis tools and modules for a passive safety design systems and methods, according to at least one instance of the present disclosure.

FIG. 9 is a diagrammatic view of a vehicle damage prediction tool, according to at least one instance of the present disclosure.

FIG. 10 is a diagrammatic view of a first notice of loss module, according to at least one instance of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the example described herein. However, it will be understood by those of ordinary skill in the art that the example described herein can be practiced without these specific details. In other examples, methods, procedures and components have not been described in detail so as not to obscure the related relevant feature being described. Also, the description is not to be considered as limiting the scope of the example described herein. The drawings are not necessarily to scale and the proportions of certain parts have been exaggerated to better illustrate details and features of the present disclosure.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “about” means almost, nearly, on the verge of, or without significant deviation from the numeric representation. The term “comprising” means “including, but not necessarily limited to”; it specifically indicates open-ended inclusion or membership in a so-described combination, group, series and the like.

The term “crash pulse” as used herein refers to an acceleration curve measured during a vehicle crash and/or crash test. The shape, time duration, and maximum acceleration of crash pulse may influence the predicted motion of one or more occupants (e.g. passengers).

As disclosed herein the passive safety design systems and methods generate useful information from data aggregated from post-crash safety systems to improve vehicle safety. In various instances of the present disclosure, aggregated data may be combined with physical and/or medical analysis to evaluate the performance of specific vehicles in specific crash scenarios.

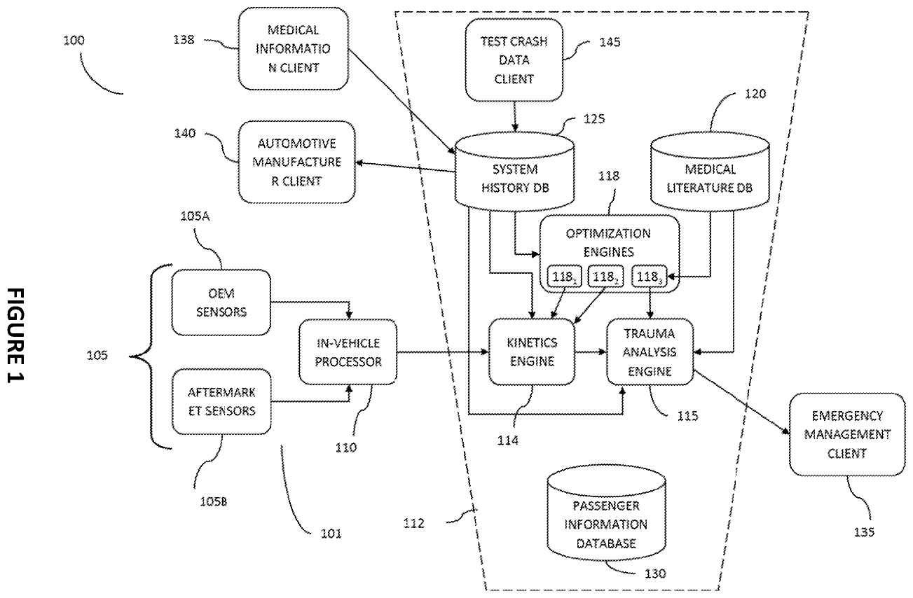

FIG. 1 illustrates an automated system 100 for evaluating and reporting of trauma to organs of passengers in a vehicular crash in real time, according to at least one embodiment of the present disclosure. System 100 comprises one or more in-vehicle sensors 105, an in-vehicle processor 110, a server 112 in wireless communication with in-vehicle processor 110, and/or client computers in communication with server 112, comprising an emergency management client 135 and a medical information client 138. The system 100 can further include an auto-manufacturer client 140 in communication with server 112. The in-vehicle sensors 105 and/or in-vehicle processor 110 can be disposed in a vehicle 101. The in-vehicle sensors 105 and/or in-vehicle processor 110 can be OEM equipment provided by the manufacturer of vehicle 101, aftermarket equipment, and/or any combination thereof.

The in-vehicle sensors 105 can include, but are not limited to, a speedometer, linear accelerometer, three-axis accelerometer, microphone, inside air temperature sensor, outside air temperature sensor, seat occupancy sensor, seat position sensor, safety belt use indicator, safety belt tension meter, airbag deployment sensor, wheel speed sensor, blind-spot monitor, throttle position sensor, braking force sensor, steering wheel position sensor, steering angle sensor, hands-on-steering wheel sensor, tire air pressure sensor, optical sensor, rear view monitor, in-cabin camera, air pressure 330 sensor, acoustic sensor, ultrasound sensor, LiDAR, RADAR, GPS, gyroscopic sensor, tachometer, passenger height sensor, passenger weight sensor, and/or any combinations thereof.

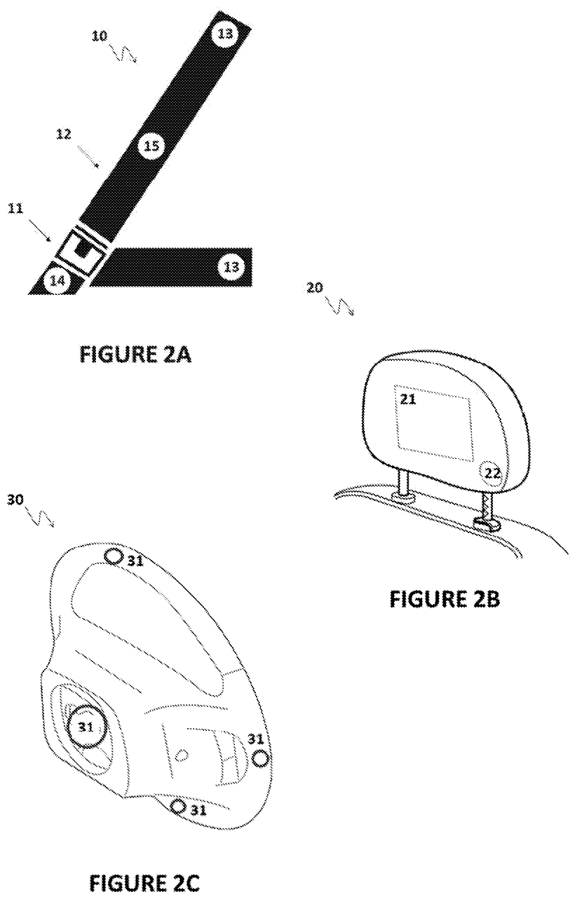

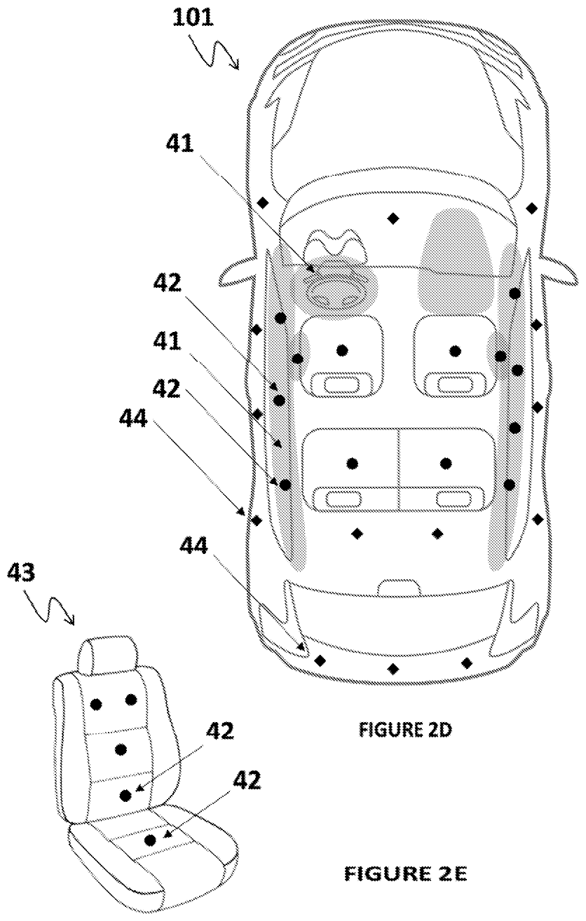

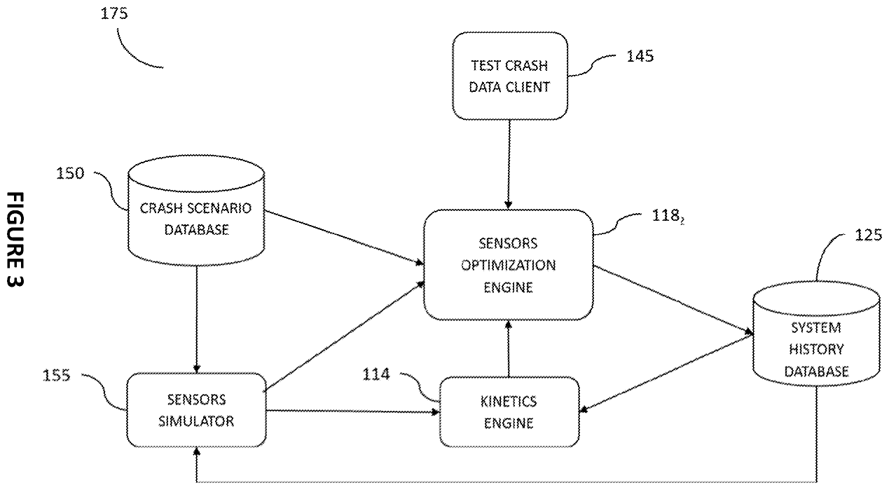

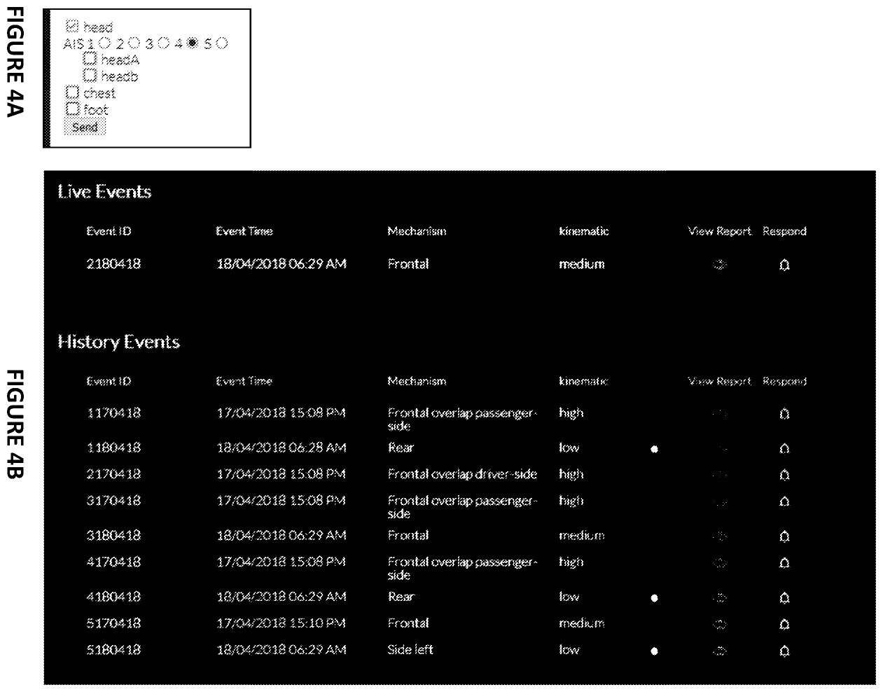

FIGS. 2A-2D, showing several kinds of in-vehicle sensors 105, according to instances of the present disclosure. At least a portion of in-vehicle sensors can be distinguished in that they are disposed in contact and/or nearly in contact with a passenger or occupant, permitting measurement of external forces on organs of the passenger during an accident. It is understood within the scope of the present disclosure, that the one or more in-vehicle sensors illustrated and described are illustrative and can be omitted and/or other sensors added in instances of the present disclosure without deviating from the present disclosure.

FIG. 2A illustrates an embodiment of a set of sensors located on a seatbelt of the vehicle. Seatbelts 10 can be made of two parts: the buckle 11, which is usually a static element, and the belt 12 which is usually a dynamic element. The belt can be a dynamic length and operable to engage with at least a portion of the buckle 11.

One or more pressure sensors 13 can be allocated in the top and/or bottom parts of the belt 12, and another pressure sensor 14 is located at the buckle 11. Furthermore, a height-adaptable heartbeat and/or respiration sensor 15 can be located on the belt 12. In at least one instance, the passenger can change the position of the heartbeat and/or respiration sensor to fit at the right place on the chest of the passenger.

FIG. 2B illustrates headrest sensors, according to at least one instance of the present disclosure. A pressure sensor 21 can measure a pressure applied by the head of the passenger on the headrest 20. The pressure sensor can 21 measure force typically applied to the head in a countercoup injury. A gyroscope 22 can measure the acceleration(s) applied on the headrest 20 by the head of the user; furthermore, the gyroscope 22 can enable correlation of the movements of the head during an accident to those of the seat, by measuring the shear force applied by the seat on the body of the passenger. The pressure sensor 21 and/or gyroscope 22 can enable measurement of forces sustained by the head in diffuse axonal injuries, measured by comparing the rotational head movement to the rotational force measured in the seat (back and bottom). Differences between those measurements will indicate shear force felt by the head and/or chest.

FIG. 2C shows a set of steering wheel sensors, according to at least one instance of the present disclosure. One or more pressure sensors 31 can be located around the circumference of the steering wheel and/or on the back surface of the steering wheel 30. The one or more sensors 31 can provide information regarding the force of the impact of the passenger on the steering wheel 30, which can tell if the passenger were wearing the seatbelt 10, or wearing their seatbelt properly, during an accident. This type of information is extremely important for the medical treatment of the impacted passenger.

FIG. 2D illustrates a plurality of sensors located in throughout a vehicle, according to at least one instance of the present disclosure. FIG. 2E illustrates a plurality of sensors disposed on a car seat, according to at least one instance of the present disclosure. A diagrammatic view of vehicle 101 and a car seat 43 are shown, together with the zones (grey areas) of inflated airbags 41. One or more pressure sensors 42 can be positioned and/or located at several places over the airbags and the seats. The one or more pressure sensors 42, and/or other possible configurations of sensors, can allow for creating a fuller picture of the movements and impacts of passengers in order to achieve a fuller picture of their potential injuries.

There are one or more sensors 44 allocated in parts of vehicle 101 that can calculate the distance between themselves. The one or more sensors 44 can enable the calculation of deformations of vehicle 101 during an accident. It has been proven that there is a direct correlation between the level of deformation suffered by the vehicle and the severity of the injuries suffered by the passengers (“Characteristics of Crashes that Increase the Risk of Serious Injuries”; J. Augenstein, E. Perdeck, and J. Stratton; Annual Proceedings of the Association for the Advancements of Automotive Medicine; vol. 47, 2003). Therefore, as part of the overall sensorial information collected by the sensors, a level of deformation of the vehicle can be measured as another parameter for subsequent estimation of the extent of the injuries suffered by passengers in vehicle 101.

Referring back to FIG. 1, in-vehicle sensors 105 can include one or more medical sensors operable to monitor a passenger in a vehicle. In-vehicle processor 110 can receive readings from the one or more in-vehicle sensors 105. Upon detection that a crash (e.g. accident) has occurred, the in-vehicle processor 110 can send data of readings received from the one or more in-vehicle sensors 105 before and up to the time of the crash. In at least one instance, the in-vehicle processor 110 continues to receive and/or send data even after the vehicle comes to rest, in case there are multiple (e.g. secondary) collisions. In at least one instance, the in-vehicle processor 110 can compress the data from the one or more in-vehicle sensors 105 before sending to the server 112. An optimal compression may result in a loss of data, but a compression algorithm employed by in-vehicle processor 110 can be specially designed to preserve data features needed by server 112 for analysis of the crash.

The in-vehicle processor 110 can also collect information about passengers in the vehicle. At the start of a ride in vehicle 101, in-vehicle processor 110 can receive one or more pieces of passenger information including, but not limited to, names, weights, heights, and/or medical conditions at each seating location in vehicle 101, from a storage device (not shown) in vehicle, from an input device (not shown) in vehicle 101, and/or a mobile device, from server 112, and/or any combinations thereof. A passenger can be identified by weight, height, and/or image, as measured by one or more applicable in-vehicle sensor 105. The passenger information can be sent together with data from the one or more sensors 105, as additional input data to improve accuracy of estimating trauma to organs of the passengers during an accident. Additionally, passenger data can be stored in a passenger information database 130 of server 112.

Server 112 can be a cloud-based server and/or a dedicated server. The server 112 can include one or more computers (including processors and/or memory) that can be disposed in different locations. Wireless communication between in-vehicle processor 110 and/or the server 112 can be established with protocols suitable for vehicle-to-infrastructure and/or vehicle-to-cloud connectivity; e.g. one or more of cellular (such as 4G or 5G), IoT, etc.

The server 112 can include modules (further described herein) that facilitate computations made by system 100. The modules comprise a non-transitory computer-readable medium (CRM), which can be any kind of memory or storage device, or combinations thereof. The CRM stores instructions for a processor of server 112 to execute the described functions of each module.

Clients, such as emergency management client 135 and/or medical information client 138, can each include a computing device, which can be a PC, notebook, and/or mobile device such as a tablet or smartphone. Each computing device comprises a wired and/or wireless means of communication with the server 112. On each client computer, a software agent may be installed, in order for the client computer to communicate with the server 112 and otherwise provide functions of the client described herein.

### Kinetics Analysis

The server 112 can include a kinetics engine 114. The kinetics engine 114 can receive the one or more sensor readings sent by the in-vehicle processor 110. The kinetics engine 114 can classifies a crash mechanism of the crash from the one or more sensor readings received therein. In at least one instance, the kinetics engine 114 can determine the impact point of the crash (e.g. a rear impact, a side impact, and/or a frontal impact collision). The classification identifies one of a discrete number of analysis regimes (e.g. readings of which in-vehicle sensors 105 to employ, which organs to analyze, and/or which algorithm to use) for further processing by the kinetics engine 114.

After classifying the crash, the kinetics engine 114 can calculate readings of virtual sensors. A virtual sensor can be an imaginary sensor virtually disposed inside of an organ of a passenger in a vehicle. The virtual sensors can convert physical quantities measured by in-vehicle sensors 105 into forces, which can include internal stresses, applied to the organ, resulting motions of the organ, and/or internal strain of the organ. In at least one instance, the kinetics engine 114 can employ various test data, data-science algorithms, and/or other computational methods, as well as the crash mechanism classification. The kinetics engine 114 can calculate one or more readings of the virtual sensors in the body of a passenger as a function of readings from the in-vehicle sensors 105.

A virtual sensor may be a force/stress sensor and/or a displacement/deflection sensor, depending on what kinetic quantity is most important for evaluating life-threatening injuries. For impacts to the head, a virtual sensor typically measures stress at the center of gravity of the head. Virtual sensors placed in the chest typically measure internal deflections, acceleration, torque, and/or force.

The kinetics engine 114 can determine body movements in order to help in calculating virtual sensor readings. For example, in a frontal crash at 50 miles per hour (mph) into a tree, the body is propelled toward the steering wheel 30 with a specific velocity and an order of impact by body organs. If the chest of the passenger (e.g. driver) hits the steering wheel 30 first and the head second, the head will jerk forward and strains in the neck would result in a hyperflexion injury. If the head hits first, the head will be held back while the chest lurches forward, resulting in a hyperextension neck injury. A steering wheel 30 adjustment sensor, passenger height sensor, seat sensors, and/or passenger height data in a passenger information database 130 can be employed to determine which mode of impact occurred. The mode of impact can be an input to a calculation for a reading of a virtual sensor positioned in a vertebra of the neck.

### Kinetics Optimization/Training

Reference is now made to FIG. 3, showing a sub-system 175 for optimizing/training the classification and virtual sensor response functions, of an automated system 100 for evaluating and reporting of trauma to organs of passengers in a vehicular crash in real time, according to at least one instance of the present disclosure. Sub-system 175 can include a crash scenario database 150, a sensors simulator 155, a kinetics engine 114, a system history database 125, a test crash data client 145, and/or a virtual sensor optimization engine 118₂ (and/or a classification optimization engine 118₁ for optimizing the classification function).

The crash scenario database 150 stores various test scenarios of car crashes; for example, car make/model, colliding body (e.g., other vehicle, concrete wall, tree, etc.), speed, braking/steering pattern, and passenger weight. Scenarios are strategically selected to minimize the number of test scenarios required to calibrate the virtual sensors. For example, at low vehicle speeds responses of some virtual sensors are expected to be nearly linear with respect to corresponding in-vehicle sensor readings, so a series of test scenarios at different vehicle speeds may be spaced by 10 mph (e.g., scenarios at 20, 30, and 40 mph). In the real-life system 100, virtual sensor responses at intermediate speeds can be calculated by interpolation of simulation data between the nearest lower and higher multiple of 10 mph. At higher speeds, virtual sensor responses may be non-linear, so that simulations and tests of crash scenarios at more closely spaced speeds, e.g. 50, 55, 60, 62, 64, 66, 68, 69, and 70 mph may be required.

Sensors simulator 155 can receive a crash scenario from scenario database 150 and calculate expected responses of in-vehicle sensors 105 to a crash of the crash scenario, as a function of the crash scenario data. Such calculations are extremely computationally intensive; using present computer technology, sensors simulator 155 is typically left to run overnight to calculate the expected readings of in-vehicle sensors 105. A sensor simulation function may employ data-science algorithms. A sensor simulation function may employ existing training data of simulated sensor readings from one or more previous simulations by sensors simulator 155, stored in system history database 125. Sensors simulator 155 may combine results of data-science and trained algorithms (e.g. machine learning) with weighted emphasis; for example, a trained sensor simulator algorithm can become more relied upon when proven to be increasingly accurate with more training.

The kinetics engine 114 is run in a simulation mode when employed in optimization/training sub-system 175, wherein the kinetics engine 114 can receive the calculated sensor outputs from the sensors simulator 155. The kinetics engine 114 can compute simulated virtual sensor readings as a function of the simulated in-vehicle sensor readings. Typically, the simulated virtual sensor response function is identical to the virtual response function used by the kinetics engine 114 in real crashes. A virtual sensor response function may employ data-science algorithms. A virtual sensor response function may employ existing training data of calculated readings of the virtual sensor from one or more previous simulations, stored in system history database 125. The kinetics engine 114 may combine results of data-science and trained algorithms with weighted emphasis; for example, a trained sensor simulator algorithm can become more relied upon when proven to be increasingly accurate with more training.

Test crash data client 145 provides data from sensors in crash dummies collected during actual crash tests. Test crash data client 145 can provide data from an automotive manufacturer, 485 from a regulatory agency such as the U.S. National Highway Traffic Safety Administration (NHTSA), or from an insurance organization such as the Insurance Institute for Highway Safety (IIHS). Test crash data may be standard (tests required by law or regulations), non-standard, or both. Some test crashes can be performed specifically for the purpose of calibrating the classification and/or virtual sensor functions. In addition to sensors in the crash dummy—corresponding to virtual sensors of system 100—test crash data client 145 may also provide data for readings of in-vehicle sensors 105.

The system history database 125 can receive and store data (and/or a reference link thereto) comprising the crash scenario from crash scenario database 150, corresponding simulated sensor outputs from sensors simulator 155, corresponding simulated virtual sensors readings from kinetics engine 114 and crash test data, performed under conditions of the crash scenario, from test crash data client 145.

A sensors optimization engine 1182 can optimize the sensor simulator function against an aggregation of one or more training sets (e.g. crash scenarios, sensor simulations, and/or in-vehicle sensor readings data from a crash test corresponding to the crash scenario) stored in system history database 125. A virtual sensors optimization engine 1182 can store parameters of the optimized in-vehicle sensor simulation function in the system history database.

In at least one instance, the sensors simulator 155 re-computes simulated sensor outputs with a newly optimized simulated sensor response function. The kinetics engine 114 can receive the re-computed sensor outputs and can compute revised virtual sensor readings, employing either the original virtual sensor response function or a newly optimized virtual sensor response function.

With more training, an aggregation of more and more collisions, simulations and/or corresponding test crash data is expected to improve accuracy of the sensor simulator and virtual sensor response functions. Optimization engines 118₁-118₂ may employ one or more optimization methods, such as random forests, linear regression, logistic regression, k-nearest neighbors, gradient boost, recurrent neural network, long-short term memory, machine learning, deep learning, neural networks, fuzzy logic, and any combination thereof.

### Trauma Assessment

Reference is now made again to FIG. 1. In at least one instance, the server 112 can include a trauma analysis engine 115. The trauma analysis engine 115 can receive virtual sensor readings from the kinetics engine 114. The trauma analysis engine 115 can assess trauma to organs of a passenger in a vehicular crash, as a function of the virtual sensor readings and medical literature in a medical literature database 120 of server 112.

The trauma analysis may be done in two stages: 1) determining the effect of a force on a tissue's physical behavior. For this first stage, the trauma analysis engine 115 may employ biomechanical models, finite elements, and 3D models; and 2) determining the effect of the tissue's physical behavior on the tissue damage and it's pathophysiology. For this second stage, the trauma analysis engine 115 may employ medical literature stored in the medical literature database 120. The medical literature comprises published medical literature (or links thereto); for example, medical journals such as Traffic Injury Prevention and/or medical references such as Accidental Injury: Biomechanics and Prevention (edited by N. Yoganandan, et al.).

The trauma analysis engine 115 can calculate an assessment of trauma to the organs. The trauma analysis engine 115 can identify which organs of the passenger were traumatized and/or severity of the trauma. The calculation output can be based on codes of the Abbreviated Injury Scale (AIS) or of the International Classification of Diseases (ICD).

Based on the calculation of the trauma analysis engine 115, server 112 can send a trauma assessment report to an emergency management client 135 of the system 100. The emergency management client 135 can be in connection with emergency medical personnel, such as an EMS unit, a hospital trauma unit, and/or hospital emergency room workers. The trauma assessment report can be push-reported to the appropriate personnel. Separate trauma assessment reports can be sent to the trauma analysis engine 115 for each passenger in vehicle 101, categorized under the same vehicular accident. Trauma assessment can include the crash mechanism classification determined by kinetics engine 114. In some instances, the trauma assessment reports are completely automatically generated.

The trauma analysis engine 115 can determine a most appropriate EMS and/or trauma unit to summon for treatment of the passenger(s). The server 112 can be further programmed to track the status of EMS and/or trauma units and select which trauma unit to summon based on distance from the crash, availability, equipment, and/or medical knowledge of the trauma units.

The trauma assessment reports can be extremely valuable to EMS and hospital personnel preparing to respond to the accident and treat the passengers, as the reports apprise the personnel of types and severity of injuries and the number of passengers needing treatment. The report can quicken the speed of response and treatment, exceptionally critical for vehicular crashes. Furthermore, the report can include injuries that are often not detected by EMS and/or hospital personnel. Thus, the report can summon medical personnel to an earlier intervention than otherwise possible.

For example, in many cases, when the abdomen is subjected to a blunt impact, solid and hollow organs are prone to major injuries. While solid-organ lacerations (e.g. liver, spleen) are visible in imaging (e.g. Ultrasound, computed tomography (CT)), injuries to hollow organs (e.g., bowel perforation) are usually undetectable. By analyzing the forces applied to the abdominal cavity, a rough estimation could be made in order to assess the potential damage.

Additionally, for example, in many cases of traumatic brain injury (TBI), deterioration in the Rotterdam score can occur during the first hours. Although the preliminary CT scan (usually taken during the first hour of treatment) seems unremarkable, by measuring the forces applied to the head during the impact, trauma analysis engine 115 can empirically assess a potential of deterioration, allowing the medical staff to respond accordingly and prevent the deterioration.

Server 112 may receive a response status from the emergency management client 135. The status may include whether an ambulance was dispatched to the scene of the accident and at what time the ambulance arrived. The status may also include the time of an admission to an emergency room and to which hospital.

System 100 further comprises a medical information client 138. The medical information client 138 provides medical examination reports prepared by EMS and/or hospital personnel during treatment (which can include emergency treatment, post-emergency inpatient treatment, outpatient treatment, and/or doctor visits) of passengers processed by system 100. The server 112 can connect with the medical information client 138. The format of the medical examination report can be specially prepared for use with system 100. FIG. 4A illustrates a GUI of a simplified example of a form for entering the medical examination report. A user of the form can check off organs that were injured in the accident. Under the organ appears selection buttons for reporting the extent of the injury on the MS scale.

The server 112 can receive medical examination reports of passengers in an accident processed by system 100. The server 112 can store the medical examination reports in the system history database 125. FIG. 4B illustrates a status information screen visible to an administrator of server 112. The screen shows live and/or historical events (e.g. crashes), times of occurrence, crash mechanisms, extent of impact, response status, and links to medical examination reports.

In some instances, the server 112 can include a trauma assessment optimization engine 1183. Trauma assessment optimization engine 1183 can optimize the trauma assessment function against an aggregation of one or more training sets including readings of virtual sensors and/or corresponding medical examination reports stored in system history database 125. The virtual sensors optimization engine 1182 can store parameters of the optimized in-vehicle sensor simulation function in the system history database 125.

With more training, an aggregation of more and more virtual sensor readings and medical examination reports is expected to improve accuracy of the trauma assessment function. The trauma assessment optimization engine 1183 may employ one or more optimization methods, such as random forests, linear regression, logistic regression, k-nearest neighbors, gradient boost, recurrent neural network, long-short term memory, machine learning, deep learning, neural networks, fuzzy logic, and any combination thereof.

In some instances, the trauma assessment optimization engine 1183 can be further configured to dynamically increase reliance on the optimization over deterministic models (e.g., biomechanical models, finite elements, and 3D models), with a growth in number of the aggregation of medical examination reports and associated virtual sensor readings.

In some instances, the server 112 can include a passenger information database 130 for one or more passengers in the vehicle. The kinetics engine 114 and/or the trauma analysis engine 115 can employ data in passenger information database 130 to personalize analysis to a specific medical condition of a patient. The kinetics engine 114 can calculate kinetics of bone tissue, depending on whether the bone tissue is normal, osteoporotic, or osteopetrotic. The trauma analysis engine 115 can calculate a probability of liver lacerations due to fibrotic tissue, as a function of a history of liver cirrhosis.

In at least one instance, to demonstrate system operation: a) based on readings of an in-vehicle seatbelt tension sensors taken during a crash, the kinetics engine 114 determines that a 186 G force was applied on the sternum of a passenger for 4 milliseconds (ms), b. the trauma analysis engine 115, employing finite element analysis, determines that the sternum compressed posteriorly by 3 centimeters (cm), and c. based on age, gender, and medical history, the trauma analysis engine 115 determines there is a 72% chance that passenger has a sternal fracture.

In at least one instance, the system 100 can include an automotive manufacturer client 140. The automotive manufacturer client 140 can connect to the server 112. The automotive manufacturer client 140 can collect aggregated data of crashes processed by system 100. The automotive manufacturer client 140 can compute a braking and/or steering pattern before and during a crash that would result in minimizing severity of injuries, against an aggregation of medical examination reports paired with in-vehicle sensor readings, in particular sensors of the braking and/or steering system. The automotive manufacturer client 140 can deploy the optimized braking and/or steering patterns in designing a crash-response system of autonomous or semi-autonomous vehicles, and/or other safety features for the vehicle.

In at least one instance, the server 112 can determine an optimal vehicle maneuver (e.g., location and/or orientation of the vehicle every millisecond prior to the crash), and the automotive client 140 can calculates steering and/or braking required by vehicle 101 to achieve the optimal maneuver.

In at least one instance, the system 100 further comprises a marketing client (not shown). The marketing client can be connected to the server 112. The marketing client can receive a trauma assessment report of a passenger from system history database 125. The marketing client can match the estimated organ trauma with promotional medical products associated with the estimated organ trauma. The marketing client can initiate a display of an advertisement for the products on a device of the passenger. In at least one instance, the marketing client can withhold sending the promotion, and/or server 112 can withhold access to the trauma assessment report, if the passenger was hospitalized for his injuries (e.g., if a medical examination report for the accident was generated by a hospital and is stored in system history database 125). In some instances, the marketing client can withhold sending the promotion if the trauma exceeds a pre-defined threshold for the organ (as indicated in the trauma assessment or medical examination report).

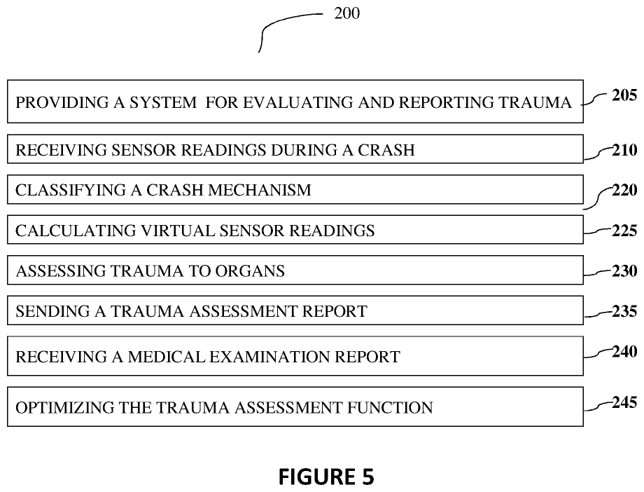

Referring now to FIG. 5, a flowchart is presented in accordance with an example method. The example method 200 is provided by way of example, as there is a variety of ways to carry out the method 200. Each block shown in FIG. 5 represents one or more processes, methods, or subroutines, carried out in the example method 200. Furthermore, the illustrated order of blocks is illustrative only and the order of the blocks can change according to the present disclosure. Additional blocks may be added or fewer blocks can be utilized, without deviating from the present disclosure. The example method 200 can begin at block 205.

At block 205, a system can be provided for evaluating and reporting trauma to organs of passengers in a vehicular crash. The method 200 can then proceed to block 210.

At block 210, the system can receive one or more sensor readings taken by one or more sensors of the system during the vehicular crash. The method 200 can then proceed to block 220.

At block 220, the system can classify a crash mechanism of the crash, as a first function of first inputs comprising the one or more sensor readings. The method 200 can then proceed to block 225.

At block 225, the system can calculate readings of one or more virtual sensors. The one or more virtual sensors can be virtually disposed inside one or more organs of a passenger in the vehicle as a second function of second inputs comprising the classified crash mechanism and/or the in-vehicle sensor readings. The method 200 can then proceed to block 230.

At block 230, the system can assess trauma to the organs, as a third function of third inputs comprising the virtual sensor readings and/or medical literature. The method 200 can then proceed to block 235

At block 235, the system can send a trauma assessment report comprising the estimated organ trauma to one or more emergency management clients. The method 200 can then proceed to block 240.

At block 240, the system can receive a medical examination report of a post-accident examination of the passenger. The method 200 can then proceed to block 245.

At block 245, the system can employ one or more optimization techniques to optimize the third function against an aggregation of a plurality of received medical examination reports and associated readings of the one or more virtual sensors.

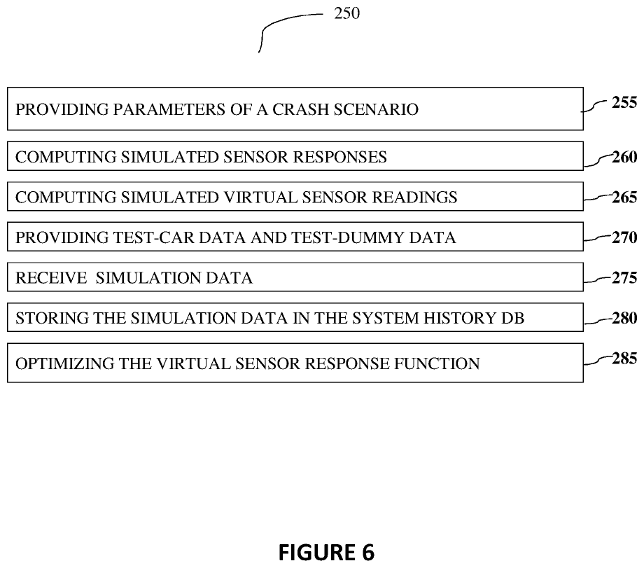

Referring now to FIG. 6, a flowchart is presented in accordance with an example method. The example method 250 is provided by way of example, as there is a variety of ways to carry out the method 250. Each block shown in FIG. 6 represents one or more processes, methods, or subroutines, carried out in the example method 250. Furthermore, the illustrated order of blocks is illustrative only and the order of the blocks can change according to the present disclosure. Additional blocks may be added or fewer blocks can be utilized, without deviating from the present disclosure. The example method 250 can begin at block 255.

At block 255, the system can provide parameters of a crash scenario (e.g. car make/model, speed, braking/steering pattern, passenger weight, etc.). The method 250 can then proceed to block 260.

At block 260, the system can compute one or more simulated sensor responses of one or more in-vehicle sensors for the crash scenario. The method 250 can then proceed to block 265.

At block 265, the system can compute simulated virtual sensor readings as the second function of the one or more simulated sensor responses. The method 250 can then proceed to block 270.

At block 270, the system can provide test-car data and test-dummy data from a crash test performed under conditions of the crash scenario. The method 250 can then proceed to block 275.

At block 275, the system can receive simulation data comprising the crash scenario, the one or more simulated sensor responses, the one or more simulated virtual sensor readings, the test-car data, and/or the test-dummy data. The method 250 can then proceed to block 280.

At block 280, the system can store the simulation data in the system history database. The method can then proceed to block 285.

At block 285, the system can optimize the second function against an aggregation of one or

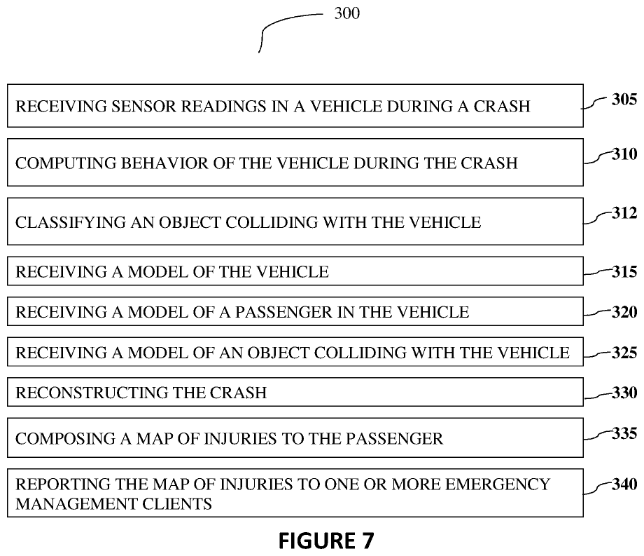

Referring now to FIG. 7, a flowchart is presented in accordance with an example method. The example method 300 is provided by way of example, as there is a variety of ways to carry out the method 300. Each block shown in FIG. 7 represents one or more processes, methods, or subroutines, carried out in the example method 300. Furthermore, the illustrated order of blocks is illustrative only and the order of the blocks can change according to the present disclosure. Additional blocks may be added or fewer blocks can be utilized, without deviating from the present disclosure. The example method 300 can begin at block 305.

At block 305, the system can receive one or more sensor readings in a vehicle during a crash. The method can then proceed to block 310.

At block 310, the system can describe behavior of the vehicle (e.g., velocity and acceleration) during the crash as a first function of the one or more sensor readings. The method 300 can then proceed to block 312.

At block 312, the system can characterize an object colliding with the vehicle as a second function of the one or more sensor readings. The method 300 can then proceed to block 315.

At block 315, the system can receive a model of the vehicle. The method 300 can then proceed to block 320.

At block 320, the system can receive a model of one or more passengers in the vehicle. The method 300 can then proceed to block 325.

At block 325, the system can receive a model of an object colliding with the vehicle (e.g. vehicle, passenger, and/or object models can be finite-elements models). The method 300 can then proceed to block 330.

At block 330, the system 300 can reconstruct the crash using one or more of the model of the vehicle, the model of the one or more passengers in the vehicle, and/or the model of the object colliding with the vehicle. The method 300 can then proceed to block 335.

At block 335, the system can compose a map of injuries to the one or more passengers. The method 300 can then proceed to block 340.

At block 340, the system can report the map of injuries to the one or more passengers to one or more emergency management clients.

Given the data acquired from the vehicle sensors, describing the vehicle behavior during the crash and computer models of (a) the vehicle model (b) a representing human model (such as GHBMC or THUMS) and (c) a representing barrier (the object to in which the vehicle has collided with), a full reconstruction of the crash can be done in real time (given sufficient computer power to conduct the full simulation in seconds). By such a reconstruction, a complete and reliable map of injuries can be composed. Since the human model represents the different organs and tissues, a very accurate analysis of the injury dynamics and diagnosis can be done.

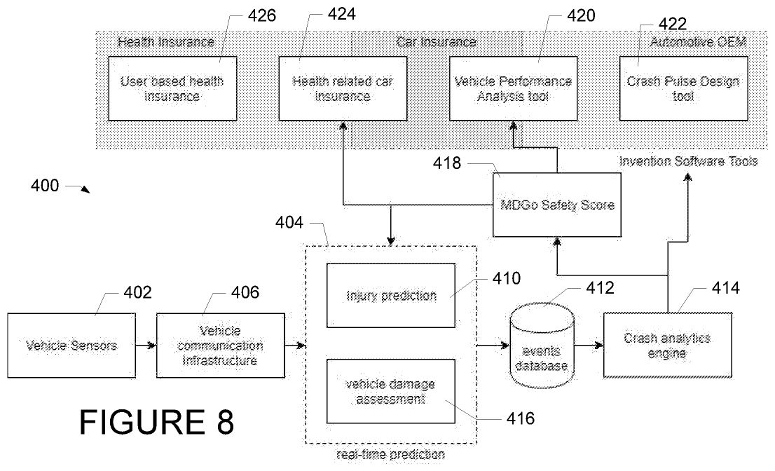

As shown in FIG. 8, the passive safety design system 400 includes a number of data analysis tools or modules 416-426, that use data collected from vehicle-based sensors and related systems, such as the automated system 100 shown and described in FIGS. 1-7. In at least one instance, the system 400 includes a vehicle damage assessment module 10, a multi-dimensional safety scoring module (MSS) 418, a vehicle performance analytics module 420, a crash pulse design module 422, a vehicular insurance policy module 424, and a health insurance data module 426. The modules 416-426 communicate with a processing or computing device and various elements of the automated system 100.

In at least one instance, the vehicle damage assessment module 416 executes on the processing device to analyze real-time trauma data similar to the trauma analysis engine 115. Further, the vehicle damage assessment module 416 provides vehicle damage assessments to both insurance providers and/or automotive original equipment manufacturers (OEMs). In various instances to the present disclosure, the vehicle damage assessment module 416 performs a multi-step process. The damage assessment module 416 can convert the crash pulse, received from a vehicle accelerometer and/or related sensors, and generate a physical damage assessment (e.g. describing vehicle deformations and affected components) from the received data. The vehicle damage assessment module 416 can generate one or more damage repair estimates. In at least one instance, the one or more damage repair estimates can be based on the physical damage assessment and/or repair cost estimates from a generic cost estimate database and/or client-specific pricing.

The crash pulse can be stored in the database and compared with a similar crash pulse from a previous claim and/or simulation, thereby allowing a “quick draw claim settlement” to be generated. The quick draw claim settlement can allow automatic claim settlement without requiring insurance agent involvement by comparing a crash with previous crashing having a known settlement value and/or damage value. In at least one instance, the system 100 can determine for a given crash pulse that each substantially similar crash pulse stored in the database was settled for a predetermined value (e.g. $2,500), and thus the given crash pulse likely can be settled for the predetermined value (e.g. $2,500). The crash pulse comparison and implementation of machine learning with the crash pulse and claim data stored in a data base can provide automated insurance claim settlement nearly instantaneously upon detection of a collision.

The multi-dimensional safety scoring module (MSS) 418 can use a multi-dimensional scaling system to investigate performance of vehicles in different scenarios with respect to the identified injuries. This scoring system can be similar to the star-ranking system of New Car Assessment Programs (NCAP) used by various government agencies; however, there are significant differences. The disclosed scaling system can be based on real-life events rather than controlled crash tests or simulated crash test and the data analyzed is not limited to a specific set of government regulated scenarios. The scaling system can better reflects the injury risk of a vehicle in different scenarios and is intended to be used by automotive manufacturers to evaluate their products and/or improve insurance providers as a planning tool for policy pricing and by consumers.

The vehicle performance analytics module 420 can be for OEMs wanting to analyze one or more statistics of vehicle performance. The vehicle performance analytics module 420 can generate a graphical user interface (GUI) operable to display configurable analytics based on post-crash analysis. A user can investigate one or more specific vehicle models against sets of features including, but not limited to, crash mechanism, velocity, time of day, driver profile, passenger position in the vehicle, and/or compare it with other available models.

The crash pulse design module 422 can allow passive safety engineers to investigate the relationship between crash pulse and resulting injuries from one or more real-life scenarios. Vehicle manufacturers and engineers, at the design stage, can predict the level of safety in different scenarios relative to various crash pulses.

The vehicular insurance policy module 424 can combine an occupant's medical background with a vehicle MSS, generated by the MSS module 418, for providing information to insurance companies that provide personal injury policies for vehicles. In at least one instance, the insurance policy module 424 can automate and/or personalize risk evaluations and insurance policy pricing for and/or on behalf of insurers.

In at least one instance, three sets of data are combined to personalize risk evaluation for the insurance policy. Data received from in-vehicle passenger health-related sensors, data received from vehicle sensors that capture driving habits (e.g. speeding, abrupt braking, tailgating, swerving etc.), and/or scores generated by the MSS module 418. Therefore, third-party end users, such as insurance companies, can use the combined medical data of the driver, the MSS generated scores for the vehicle, and/or determined driving patterns to generate a risk assessment and then price an insurance policy accordingly.

The health insurance data module 426 can expand upon the medical analysis performed by the automated system 100 during crash events to perform regular monitoring of the vehicle occupants as a greater variety of health-related sensors are integrated into vehicles, including but not limited to, heart-rate monitors, pupil dilation sensors, and/or respiratory monitors. The health insurance data module 426 can use raw data from one or more health-related sensors in a vehicle combined with relevant personal medical background to regularly check and update the occupant medical state of the vehicle occupants. In some instances, the health insurance data module 426 can further communicate with a medical professional and/or health insurance provider. The health insurance data module 426 of allows end-users (e.g. vehicle owners) can enjoy personalized health insurance offers and/or premiums with fewer visits to a physician, while also allowing health insurance providers to effectively detect changes in their clients' medical states, react accordingly and/or reduce the amount and/or size of insurance claims.

FIG. 8 further illustrates a general flowchart of data transmission between the modules 416-426 and various aspects of the automated system 100. As can be appreciated in FIG. 8, the vehicle sensor system 402 and the vehicle communication infrastructure 406 can collect data and provide data to remote data server 404, which may be separate from the vehicle and may be similar to the server 112, as described with respect to FIG. 1. As shown, the remote data server 404 may further include an injury prediction module 410 that can include the functionality of the kinetics engine 114 and trauma analysis engine 115. The injury prediction module 410 can compare personal injury reporting methods and/or translate the predicted injury into an expected injury claim value. The injury prediction module 410 can implement various aspects of the automated system 100 to determine the predicted personal injuries for one or more passengers involved in a crash and the correlate the predicted injuries with an expected medical insurance injury claim value. In various embodiments, the real-time processing is reported to relevant clients, including, but not limited to, automotive manufacturers, automobile insurance providers, health care providers, and/or health insurance providers, while also retained within databases 412 of the passive safety design system 400. The crash analysis model 414 can be a processing device, having a processor and/or memory that can retrieve data from one or more databases 412 to analyze aggregations of events amongst the various modules 416-426. The output from the MSS 418 can be provided to the vehicle performance analytics module 420, and/or the vehicular insurance policy module 424.

The automated system 100 can also include a vehicle to vehicle data communication (e.g. WiFi, Bluetooth, infrared, and/or similar communication protocol). The vehicle to vehicle data communication can include, but is not limited to, a damage assessment, personal information, a crash pulse, and/or the like, thereby preventing crash victims from having to exchange information at the scene, which in the event of minor fender bender accidents can thus prevent traffic impedance. The vehicle to vehicle communication can further provide an accurate representation of damage without requiring inspection at the time, or when one or more vehicles may have included prior damage. The vehicle to vehicle data communication data set can similarly be communicated third party insurance carriers for each respective vehicle.

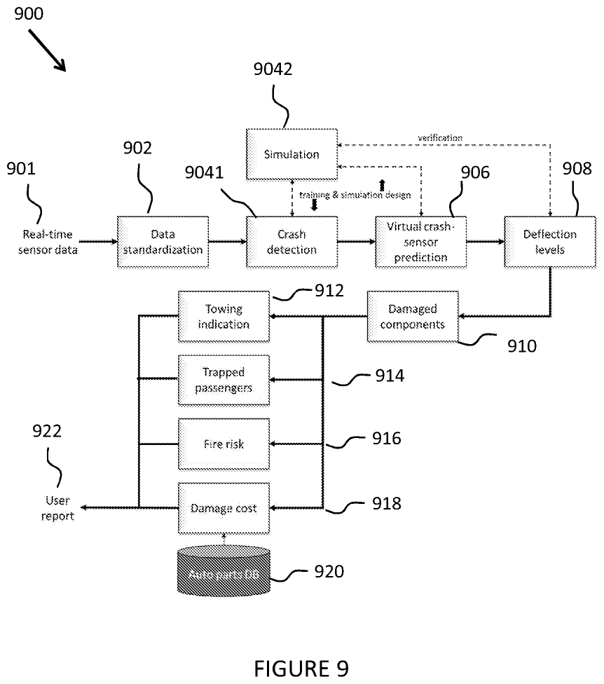

FIG. 9 illustrates a general flow chart for automatic vehicle damage prediction, according to at least one instance of the present disclosure. The vehicle damage prediction tool 900 can be operable to provide a real-time and/or nearly instantaneous snapshot of potential damage to a vehicle involved in a collision. In at least one instance, the vehicle damage prediction tool 900 can be provided in combination with the FNOL as prepared by the vehicle insurance policy module 424 as described with respect to FIG. 8.

The vehicle damage prediction tool can receive real time sensor data 901 from one or more in-vehicle sensors (such as those described with respect to FIGS. 1-4) and process the data for standardization 902. In some instances, the real time sensor data 901 can include raw 3-axis accelerometer data. The standardized data 902 can be fed to a crash detection element 9041 to determine whether a vehicle has been involved in an event defined as a crash (e.g. an event that exceeds a predetermined threshold). The vehicle damage prediction tool 900 can also implement a simulation 9042 operable to simulate a vehicle collision, including potential sensor data representative collision. The simulation 9042 can be operable to train and/or simulation collisions to improve the accuracy of the vehicle damage tool 900.

The crash detection 9041 and/or the simulation 9042 can provide data to a virtual crash-sensor prediction 906 operable to determine a virtual crash-sensor prediction, and the likely affected areas of a virtual vehicle exposed to the received real-time sensor data 901. The virtual crash-sensor prediction data can be transmitted to a deflection level 908 determination module. The virtual crash-sensor prediction can implement machine learning algorithms which can be trained using crash tests, crash simulations, and/or crash data to provide training data to improve the accuracy crash-sensor prediction 906.

The deflection level 908 determination can translate the virtual sensor readings into a resultant deflection in the one or more areas of the virtual sensors, which can be fed to a damaged components 910 operable to determine and/or predict the affected (e.g. damaged) components in an affected area of the vehicle. The vehicle damage prediction tool 900 can utilize the identified damage components 910 to determine a towing indication 912 (e.g. whether the collision is likely to require a tow truck), a trapped passenger indication 914, a fire risk 916, and/or a damage cost 918.

The vehicle damage prediction tool 900 can access an auto parts database 920 to determine an accurate damage cost 918 by providing a current price estimate for the likely damaged components. The auto parts database 920 can be an OEM parts supplier, third part parts supplier, and/or combinations thereof.

In at least one instance, the damage cost 918 can indicate a repair timeline based on parts availability at the auto parts database 920 and/or the average installation time of the associated damaged components 910.

The vehicle damage prediction tool 900 can output a user damage report 922 which can include, but is not limited to, a FNOL notification to an insurance provider, damage assessment to assist in rapid claim settlement, provide better service to clients through the available real-time data including directing a repair shop, providing a tow truck, etc. In at least one instance, the vehicle damage prediction tool 900 can be operable to determine the operability and/or inoperability of a vehicle post-crash. In the event of inoperability, the vehicle damage prediction tool 900 can access a ride-sharing platform to request transportation and/or request road side assistance (e.g. a tow truck). In at least one instance, the damage report 922 can be communicated directly to an insurance agent, thereby allowing the insurance agent to provide advice on whether to involve the insurance carrier based on the expected claim value.

In at least some instances, the vehicle damage prediction tool 900 can receive a feedback score relating to the accuracy of the damage components 910, tow truck indication 912, trapped passengers 914, fire risk 916, and/or damage cost 918 based on the received real-time sensor data 901, thereby providing the vehicle damage prediction tool 900 with a machine-learning (e.g. self-learning) capability to progressively produce more accurate damage reports 922.

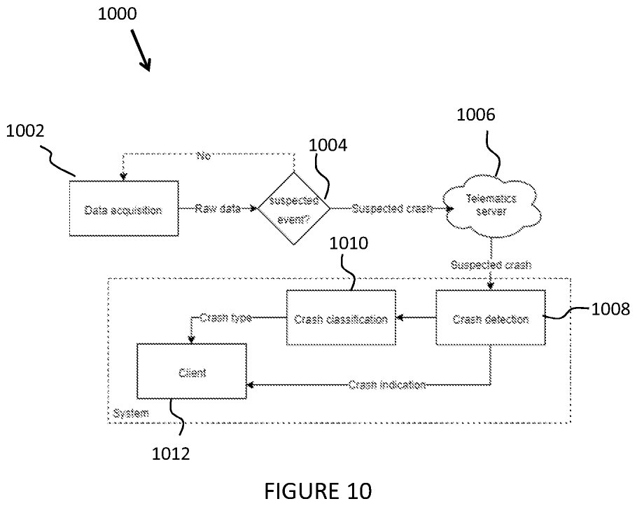

FIG. 10 is a flow chart of a first notice of loss module, according to at least one instance of the present disclosure. The first notice of loss module 1000 can be implemented a first phase of crash analysis (e.g. injury risk analysis, damage predictions, etc.) and/or as a separate module for crash detection and/or classification. In at least one instance, the first notice of loss module 1000 can be a submodule of the vehicle policy module 424, described above with respect to FIG. 8.

The first notice of loss module 1000 can be operable to receive data 1002 of a suspected event 1004 (e.g. a vehicular crash) from the crash pulse module 422 including, but not limited to, a 3-axis acceleration signal of an event that exceeds a predetermine threshold. The first notice of loss module 1000 can allow a user (e.g. insurance company, insurance agent, etc.) to define the predetermined threshold required to determine the suspected event 1004 was a crash. In at least one instance, the determination of a suspected event 1004 is a binary decision. In other instances, the determination of a suspected event can be a sliding scale and/or probability determination.

Upon determination of a suspected event 1004 exceeding the predetermined threshold, the first notice of loss module 1000 can communicate with a server 1006 regarding the suspected event 1004. In some instances, the first notice of loss module 1000 can implement a machine-learning algorithm operable to classify the suspected event 1004 as a crash indication, either a vehicle crash or non-vehicle crash based on the received data. The crash indication can be a user-defined algorithm operable to determine the crash indication. In at least one instance, the user-definition of the crash indication can allow a user to receive a crash indication for all crashes greater than a predetermined threshold, thereby allowing the user to eliminate minor fender benders, or other collisions below the predetermined threshold. After the suspected event 1004 is communicated via the server 1006 as a crash detection 1008 indicating a crash, a crash classification 1010 can be determined and/or classified by the machine-learning algorithm. The crash classification 1010 can include, but is not limited to, road bump, rollover, high dynamics, door and/or trunk slamming, bump-to-bump (e.g. fender bender), multiple collision, side impact, front-end collision, rear-end collision, and the like.

The crash detection 1008 and/or the crash classification 1010 can be communicated to a user and/or client 1012 (e.g. an insurance company, insurance agent, etc.). In at least one instance, the crash detection 1008 is communicated directly to the client 1012 without a crash classification 1010.

The first notice of loss module 1000 can operably receive a first notice of loss (FNOL) allowing an insurance company and/or insurance agent to prepare for an impending claim, assign an appropriate claim agent, line up rental cars, body shops, and/or the like.

In some instances, the first notice of loss module 1000 can send data to first responders if the crash indication exceeds a predetermined threshold that would require first responders including, but not limited to, police, fire, and/or ambulances. The end customer (e.g. first responders, insurance agent, and/or insurance companies, etc.) can independently adjust the system to provide notifications at one or more predetermined thresholders and/or to one or more predetermined users.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

Further, the methods and processes described herein can represents one or more processes, methods, and/or subroutines and the described order is illustrative only and the order can change according to the present disclosure. Additional processes, methods, and/or subroutines may be added or fewer utilized, without deviating from the present disclosure.

What is claimed is:

1. An automated system for evaluating and reporting of vehicle crash information based vehicular crash data in real time; the system comprising:
one or more vehicle based sensors operable to collect vehicle data during a crash of a vehicle;
an in-vehicle processor operable to receive data from the one or more vehicle based sensors;
a server in communicative connection the in-vehicle processor, the server comprising one or more processors, non-transitory computer-readable media (CRM), a database; wherein the server receives data transmitted from the in-vehicle processor;
one or more modules executable by the one or more processors; the one or more modules further comprising at least one of:
a vehicle damage assessment module operable to identify vehicle damage during the crash and generate a damage report based on the vehicle damage;
a multi-dimensional safety scoring module operable to quantify a performance of the vehicle based on vehicle damage compared with real crash data stored in the database, the multi-dimensional safety scoring module operable generate a vehicle safety score; and
at least one passive safety design module operable to generate a customized passive safety data for one or more third-party end user;
wherein the server transmits at least one of the damage report, the vehicle safety score, and/or the customized passive safety data to the one or more third-party end user.

2. The system of claim 1, wherein the at least one passive safety design module comprises at least one of:
a vehicle performance analytics module operable to generate a graphical user interface displaying configurable analytics based on a post-crash analysis;
a crash pulse design module operable to determine a correlation between a crash pulse and resulting injuries, thereby operable to predicting safety level for automotive design;
a vehicular insurance policy module operable to automatically personalize a risk evaluation and insurance policy pricing based upon a passenger medical background and the vehicle safety score; and/or
a health insurance data module operable to analyze data from the one or more in-vehicle passenger sensors and/or the passenger medical background to generate health insurance underwriting data for use by the one or more third-party end user.

3. The system of claim 1, wherein the crash pulse is stored on the server, and the crash pulse is correlated to a similar previous crash pulse, thereby forming a quick draw claim settlement.

4. The system of claim 1, wherein the server transmits a vehicle damage assessment provided by the vehicle damage module to at least one of an insurance provider and/or an automotive original equipment manufacturer (OEM).

5. The system of claim 1, wherein the one or more vehicle based sensors include at least one 3-axis accelerometer.

6. The system of claim 1, wherein the vehicle damage assessment module is operable to receive data from the one or more vehicle based sensors to generate a damage assessment report.

7. The system of claim 6, wherein the damage assessment report includes at least one of: a cost estimation, a fire risk, a trapped passengers indication, and/or a towing indication, wherein the cost estimation is an estimated price for repair of the vehicle, the fire risk is the probability of a fire resulting from the crash, the trapped passenger indication is the probability of one or more passengers trapped within the vehicle as a result of the crash, and the towing indication is the probability of the vehicle requiring a tow truck.

8. The system of claim 1, further comprising a first notice of loss module, wherein the first notice of loss module is operable to receive data from the one or more in-vehicle sensors to analyze the data to identify the crash.

9. The system of claim 8, wherein the first notice of loss module is operable to determine if the data exceeds a predetermined crash pulse threshold defining, and is operable to generate a crash classification.

10. The system of claim 9, wherein the first notice of loss module is operable to transmit a first notice of loss if the data exceeds the predetermined crash pulse threshold and is operable to transmit the crash classification.

11. An system for evaluating and reporting of vehicle crash information, comprising:
a vehicle operable to evaluate and report vehicle crash information, the vehicle having one or more processors and a memory coupled therewith, the one or more processors operable to execute instructions stored in the memory that causes the system to:
receive data from one or more in-vehicle sensors operable to collect vehicle data during a crash of a vehicle;
receive data from one or more in-vehicle passenger sensors operable to collect patient health data readings prior to, during, and/or after the crash of the vehicle;
generate at least one of a vehicle damage report based on the one or more vehicle based sensors, a vehicle safety score based on vehicle damage compared with real crash data stored in a database, and a customized passive safety data, wherein the vehicle safety score is generated via a multi-dimensional safety scoring module and quantifies a performance of the vehicle;
transmit at least one of the vehicle damage report, the vehicle safety score, and/or the customized passive safety data to one or more third-party end users.

12. The system of claim 11, wherein the at least one passive safety design module comprises at least one of:
a vehicle performance analytics module operable to generate a graphical user interface displaying configurable analytics based on a post-crash analysis;
a crash pulse design module operable to determine a correlation between a crash pulse and resulting injuries, thereby operable to predicting a safety level for automotive design;
a vehicular insurance policy module operable to automatically personalize a risk evaluation and insurance policy pricing based upon a passenger medical background and the vehicle safety score, the insurance policy module operable to generate a medical risk evaluation and a medical insurance policy pricing and/or a vehicle risk evaluation and a vehicle insurance policy pricing; and/or
a health insurance data module operable to analyze data from the one or more in-vehicle passenger sensors and/or the passenger medical background to generate health insurance underwriting data for use by the one or more third-party end user.

13. The system of claim 11, wherein the one or more in-vehicle sensors include at least one 3-axis accelerometer.

14. The system of claim 11, wherein the vehicle damage assessment module is operable to receive data from the one or more vehicle based sensors to generate a damage assessment report.

15. The system of claim 14, wherein the damage assessment report includes at least one of: a cost estimation, a fire risk, a trapped passengers indication, and/or a towing indication, wherein the cost estimation is an estimated price for repair of the vehicle, the fire risk is the probability of a fire resulting from the crash, the trapped passenger indication is the probability of one or more passengers trapped within the vehicle as a result of the crash, and the towing indication is the probability of the vehicle requiring a tow truck.

16. The system of claim 11, further comprising a first notice of loss module, wherein the first notice of loss module is operable to receive data from the one or more in-vehicle sensors to analyze the data to identify the crash.

17. The system of claim 16, wherein the first notice of loss module is operable to determine if the data exceeds a predetermined threshold crash pulse, and is operable to generate a crash classification.

18. The system of claim 17, wherein the first notice of loss module is operable to transmit a first notice of loss if the data exceeds the predetermined crash pulse threshold and is operable to transmit the crash classification.

19. A method for evaluating and reporting vehicle crash information, the method comprising:
receiving data from one or more vehicle based sensors during a crash of a vehicle;
assessing a vehicle damage to the vehicle during the crash;
generating at least one of a vehicle damage report, a vehicle safety score, and a customized passive safety data, wherein the vehicle safety score is generated by quantifying, via a multi-dimensional safety scoring module, a performance of the vehicle based on the vehicle damage, the vehicle damage compared with real crash data stored in a database;
communicating at least one of the vehicle damage report, the vehicle safety score, and/or the customized passive safety data to one or more third-party end users.

20. The method of claim 19, further comprising determining, via crash pulse design module, a correlation between a crash pulse and resulting injuries, thereby predicating a safety level for a vehicle design.
